(19) United States
(12) Patent Application Publication
(10) Pub. No.: US 2007/0294032 A1
(43) Pub. Date: Dec. 20, 2007

(54) Navigation using tracking system multi-function devices

(76) Inventors: Philip J. Zumsteg, Shorewood, MN (US); D. Michael Shields, St. Paul, MN (US)

Correspondence Address: Kris T. Fredrick, Esq.;Patent Services, Honeywell International Inc., 101 Columbia Road, Morristown, NJ, 07962, US

(21) Appl. No.: 11/453,732

(22) Filed: Jun. 14, 2006

(51) Int. Cl. G01C 21/32

(52) U.S. Cl. 701/213; 701/211

(57) ABSTRACT

A system for selectively acquiring, processing and displaying 3-D waypoints in a manner suitable for the purpose of providing selected hands-free navigation guidance to a user. The system includes a plurality of multi-function devices for defining a frame of reference, at least one of the plurality being adapted to be carried by the user. A communication link provides communication between the plurality of multi-function device means to form a mesh network. The multi-function devices calculate, exchange and process waypoint information indicative of the location of itself, the device carried by the user, and at least one other the device means to thereby provide the route taken by the user. A display gives a 3-D navigation guidance to the user.

### FIELD OF THE INVENTION

The present invention relates a multi-function tracking device and tracking system. More particularly, the present invention relates to the automatic acquisition, selection and processing of position information provided by a multi-function tracking device which is automatically displayed as user-selected navigational information.

### BACKGROUND OF THE INVENTION

Numerous systems, devices and methods have been developed to determine the locations of one or more cooperating devices, such as the global positioning system (GPS) and tagged asset tracking systems. Some systems, typically GPS, but not tagged asset tracking systems, are capable of acquiring and storing a list of multiple locations, or waypoints, in the locating device. These waypoints may represent past, present and future locations the tracking device may visit. Further, some such tracking devices are able to manipulate the waypoint list in various ways, such as a display indicating the user's current position with respect to a selected waypoint. Selection and entry of waypoints into the list is typically performed manually. Further, there is no interaction between tracking devices in these systems to enable one device to selectively alter the waypoint list of another device.

Existing tagged asset tracking systems do not provide comprehensive navigation information in real-time at the tracking device, such as while a tracking device is in motion. Instead, the position of the tracking device is periodically updated to the extent possible within the system. Tagged asset tracking systems are capable of capturing high resolution tracking data at a central processing location. Waypoint information in tagged asset tracking systems is determined by processing the historical movement data and device positions are not available in real-time. Further, such high resolution tagged asset tacking systems are typically designed with unidirectional communications, from the tagging device to the pre-installed tracking equipment comprising the frame of reference. Hence, the tagging device is not capable of providing navigation information locally at the tagged asset.

GPS devices are capable of providing periodic position updates, such as when a GPS tracking device has a sufficient number of satellite signals to determine a position of the device. However, the combination of a best attainable accuracy on the order of several meters horizontally, constrained maximum number of stored waypoints, and time to manually perform a waypoint entry into a list, cause such devices to exceed the necessary real-time performance for waypoint selection and navigation while a hand-held device is moving. Hence, a GPS waypoint list represents relatively widely spaced positions, between which there is no information regarding navigation. Some hand-held GPS devices are capable of acquiring the GPS position coordinates of other like devices when manually activated for the purpose of exchanging such GPS position information. Further, some GPS devices display waypoints on a two dimensional (2-D) map, possibly with a compass heading indication from the current position to a selected waypoint, though the user is responsible for proper orientation and navigation between the current position and the selected waypoint.

Some GPS devices are augmented with a dead reckoning module (DRM), such as disclosed in U.S. Pat. No. 5,583,776 to Levi et al., the disclosure of which is incorporated herein by reference in its entirety. This DRM is a microcomputer-assisted position finding device that integrates GPS data, dead reckoning sensors, a barometric altitude sensor and digital maps, with a built-in RF transponder. The Levi et al. DRM provides ground speed/distance measurements and computer-aided position fixes. One such DRM device is available from Point Research Corporation, of Santa Ana Calif. as the product Dead Reckoning Module DRM®. The Dead Reckoning Module is a miniature, self-contained, electronic navigation unit that provides the user's position relative to an initialization point. The device includes a built in GPS receiver. A microprocessor performs dead reckoning calculations and includes a Kalman filter to combine the dead reckoning data with GPS data. The Kalman filter and other proprietary algorithms use GPS data to calibrate dead reckoning sensors for typical dead reckoning accuracy of 2 to 5 percent of distance traveled from the last position fix, entirely without GPS. These devices are intended for use by personnel on foot, and are not for use on vehicles.

Similar devices, such as the Honeywell DRM-III Dead Reckoning Module for Personnel Positioning, are capable of collecting device position information at a rate of 4 samples/Sec. for in excess of 30,000 samples, during a time period exceeding 125 minutes. However, the device does not provide a means of displaying, or manipulating this data in real-time, as all data processing and display occurs after transferring the data from the DRM-III to a personal computer running appropriate software. With an accuracy of 2 percent to 5 percent of the distance traveled, using only dead reckoning, a user might be off course by up to 5 meters after moving just 100 meters. Further, the altitude sensor, for reporting the vertical location coordinate, has an accuracy of 3 meters, or greater than the typical floor to ceiling distance of 9 feet found in many structures.

The current state of the art for three dimensional (3-D) waypoint acquisition and display in hand-held devices may be categorized as providing a fixed frame of reference, having either distributed or centralized position information availability. Hand-held GPS devices provide manual selection of an individual waypoint, possibly sharing position information with another such device when manually activated. Or a centralized location monitors waypoint information provided by the hand-held devices, but is not shared among such hand-held devices. The frame of reference for GPS devices is a constellation of satellites orbiting the earth. Tagged asset systems typically provide waypoint information of a tagged device in a historical manner, only at a centralized location, with respect to the fixed frame of reference provided by pre-installed equipment.

Many potential applications exist which require real-time automatic 3-D waypoint management and navigational guidance, such as first responders working in a structure to perform search and rescue or fire fighting, or military personnel involved in reconnaissance of caves, tunnels and other underground regions. These applications are characterized by the absence of a global frame of reference, due to a lack of pre-installed equipment to support tagged asset tracking systems, or because GPS signals are typically unavailable in many structures and underground.

The accuracy of GPS, even when augmented with DRM, is insufficient to accurately guide first responders in a structure, as the optimum accuracy of DRM-based position determination is 2 percent over 100 meters resulting in an error of 2 meters, or more than twice the width of a typical doorway. GPS, even when enabled with Wide Area Augmentation System (WAAS) is only capable of resolving position within 3 meters and vertical height within 7 meters, and only when such WAAS signals are available. Further, the GPS-augmented with DRM has a vertical resolution of 3 meters, or greater than the floor to ceiling distance in many structures. As a result, such systems may report ambiguous information regarding the vertical location within a region where a first responder is located. For a first responder, disoriented in a structure, every foot is precious, as documented in “U.S. Firefighter Disorientation Study”, July 2003, William R. Mora, Captain, San Antonio Fire Department, San Antonio, Tex.), U.S. Fire Administration (USFA/FEMA) report “Firefighter Fatalities in the United States in 2003”, August 2003, and the U.S. Fire Administration (USFA/FEMA), “Improving Firefighter Communications—Special Report”, Report 099, 1994.

Further, firefighters using self-contained breathing apparatus (SCBA) have a time-limited air supply, hence a reliable and time-efficient method for reaching the fireground, and exiting safely, even in heavy smoke conditions with restricted visibility, is critical to maximize the time spent working on the fire.

It would be of advantage in the art if a system could be devised that would permit user-selected of multiple sets of 3-D position and accuracy information to be obtained from a multi-function tracking device and automatically processed into navigational guidance for the user.

Yet another advantage would be if a device could be developed that would allow the selection and processing from a set of multiple such 3-D position and accuracy information to automatically determine an appropriate sequence of navigation information to guide a user on a particular route.

Still another advantage would be if the 3-D navigation information could be displayed in a manner to enable hands-free operation by the user.

Other advantages will appear hereinafter.

### SUMMARY OF THE INVENTION

It has now been discovered that the above and other advantages of the present invention may be obtained in the following manner. Specifically, the present invention provides a system including devices for acquiring and exchanging selected 3-D positions, or waypoints, related to a device which is capable of tracking and recording movement and position, and which processes a selected set of waypoints for the purpose of providing navigational guidance to a user.

All data acquisition, processing and presentation of navigational guidance is performed automatically by the device, after selection of an operating mode, either locally by the user or remotely. Further, each such device may automatically exchange waypoints, current position and navigational guidance information with other such devices.

The present invention is admirably suited for use in buildings and below ground regions, particularly in buildings and regions that may be at risk from damage, such as by earthquake, hurricanes, tornadoes, wars, terrorism and the like. First responders will be dispatched and, thus, will be at risk themselves. For this reason the present invention is used to track their movement, by providing ongoing acquisition and storage of 3-D position information and presentation of navigational guidance within such regions.

In the case of a first responder scenario, such as a disoriented first responder, the device provides a “safety” navigational guidance mode, which automatically provides the user with position-dependent directions for exiting the region.

Further, the device may provide a “rescue” mode by merging waypoints exchanged with other devices in order to determine a new route between devices and display 3-D navigational guidance for any user to locate any other user.

Such a system does not rely solely on a fixed frame of reference, but instead may create one or more relative frames of reference by utilizing a combination of sensed movement and location information from fixed location, ad hoc emplaced and mobile cooperating devices

### BRIEF DESCRIPTION OF THE DRAWINGS

For a more complete understanding of the invention, reference is hereby made to the drawings, in which:

FIG. 1 is an exemplary illustration of one possible scenario of a device of the present invention acquiring 3-D waypoint information for the purpose of selectively manipulating the list of waypoints to provide a user with navigational guidance; and

FIG. 2 is an exemplary depiction of a navigational guidance device of the present invention; and

FIG. 3 is an exemplary flowchart of the behavior of a navigational guidance process of the present invention; and

FIG. 4 is an exemplary illustration of several hands-free displays for 3-D navigational guidance of the present invention; and

FIG. 5 is an exemplary illustration of a hands-free display for 3-D navigational guidance, and preferred embodiments, of the present invention.

### DETAILED DESCRIPTION OF THE PREFERRED EMBODIMENT

The present invention provides for substantial improvements in a system for acquiring 3-D waypoints, performing selected processing on at least a subset of waypoints, and providing hands-free navigational guidance to a user. Such a system acquires waypoint and position information, and access to mesh network communications, by means of a suitable multi-function device, such as that described in U.S. application Ser. No. 11/399,855, filed Apr. 7, 2006 to Zumsteg and Huseth (hereinafter the '855 application), the disclosure of which is incorporated herein by reference in its entirety.

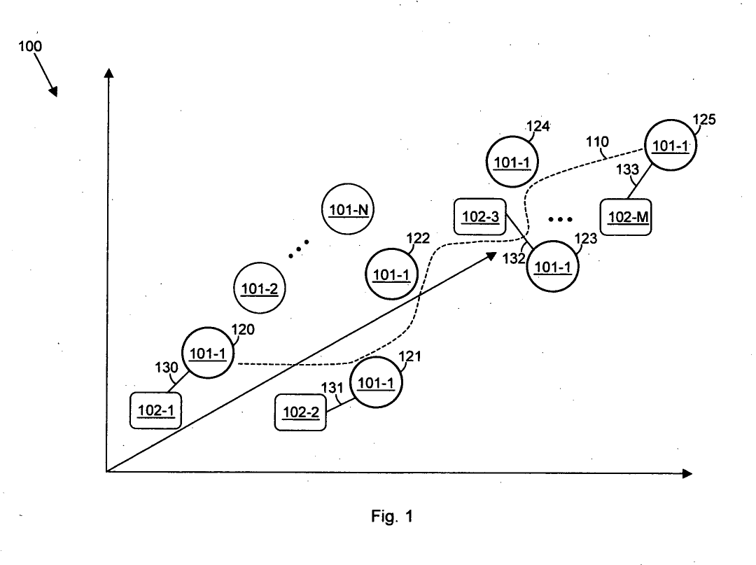

As shown in FIG. 1, a system 100 has a plurality of multi-function devices 101-1 through 101-N and 102-1 through 102-M, all of which are adapted to communicate with each other using communication links to create a mesh network as described in the '855 application. One or more pluralities of devices in the system, such as devices 102-1 through 102-M, may use the mesh communications network to cooperatively form one or more absolute or relative frames of reference for position determination by a plurality of other devices, such as 101-1 through 101-N. Each of the plurality of devices 101-n and 102-m that form each frame of reference, may belong to one of more of the frames of reference. Hence, any multi-function device 101-n and 102-m may independently determine a current position, by interacting with one or more other multi-function devices 101-n and 102-m, as described in the '855 application. Further, each of the devices 102-m may be fixedly mounted in a known location or emplaced in an ad hoc manner, such as devices emplaced by first responders as they work in a building.

A plurality of devices 101-n are embodiments of the current invention and are mobile devices, such as worn by first responders or other users, which may follow an arbitrary path 110 in 3-D space delineated by devices 102.m. As described in the '855 application such devices 101-n determine a current position using a combination of motion sensing and interaction with other devices, such as 101-n and 102-m. The position thus determined by any device 101-n and 102-m may be either with respect to a fixed frame of reference, such as when devices 102-m are fixedly mounted in known locations, or a relative location with respect to the ad hoc emplaced devices 102-m. In particular, a first responder may delineate a preferred route 110 for moving about a structure by ad hoc emplacing devices 102-m in an appropriate manner. The plurality of devices 102-m determine relative locations with respect to other such devices 102-m, using a designated point of origin for the relative frame of reference such as with device 102-1, which may be placed external to the structure at an appropriate point of entry. As will be understood by those of skill in the art, the plurality of devices and plurality of frames of reference and selection of one or more reference origins are not limitations of the present invention.

Each device 101-n is an embodiment of the present invention, and periodically determines the 3-D spatial position of that device, storing the location information in a list of positions, or waypoints. Devices 101-n also acquire waypoints from other devices 101-n and 102-m, using the mesh communications network, and storing the information in device 101-n in uniquely identified lists. For each waypoint so acquired, device 101-n may also associate a time sequence to relate the time interval or sequence in which the waypoints were acquired.

In FIG. 1, an exemplary route 110 is followed by device 101-1. As will be understood by those with skill in the art, a system 100 is dynamic, and many permutations of device locations and routes could occur. Said locations and routes are not knowable in advance, hence it must be understood that due to the dynamic and self-configuring nature of such a system, numerous other operation modes, in addition to the one described, are possible and are to be included by this disclosure.

Preferentially, device 101-1, and all other devices 101-n and 102-m, are initialized at the same point designated as the origin of the frame of reference, such as device 102-1. Devices 102-m independently determine the ad hoc emplaced position using a combination of motion sensing and one or more previously established frames of reference as described in the '855 application.

Devices 102-m may periodically collect waypoint information. Further, the devices such as 101-1 periodically collect waypoint information 120 through 125, such as when the user of device 101-1 is emplacing ad hoc devices 102-2 through 102-M. As devices 102-m are emplaced, devices such as 101-1 and 102-m exchange and process waypoint information, such as 130 through 133, collected by devices such as 102-m with waypoint information collected by devices such as 101-1 to create a waypoint list for route 110. The route 110 waypoint list describes each route segment using the relative frame of reference created between pairs of devices, such as between devices 102-1 and 102-2, and devices 102-2 and 102-3, and other pairs of devices, without limitation. The route 110 waypoint list uses sufficient 3-D positional detail to subsequently process the waypoint list for the purpose of accurate hands-free display of 3-D navigation guidance to the user. All possible pairings of devices between and among devices 101-n and 102-m are not knowable in advance, hence it must be understood that due to the dynamic and self-configuring nature of such a system, numerous other operation modes, in addition to the one described, are possible and are to be included by this disclosure.

The mesh communications network described in the '855 application provides for the exchange of the route 110 waypoint list with other devices 101-n and 102-m. Further, since each device 101-n may exchange waypoint lists with other devices 101-n and 102-m using the mesh communications network created by devices 101-n and 102-m, the waypoint information from a device, such as 101-1, may be exchanged with other devices, such as 101-2 through 101-N, enabling device 102-2 to provide information suitable for navigational guidance along the route 110 to one or more different users.

Since each device 101-n has the capability to process at least a selected set of waypoint information, numerous new routes may be determined in response to selection of the desired navigational guidance to be displayed, including, but not limited to, reversing the waypoint list describing route 110 to enable navigational guidance to be developed for returning to an origin device such as 102-1, and exchanging and merging waypoint lists from two devices 101-n such that a new route from one such device 101-n is developed to another such device 101-n, which may include using both devices 101-n and 102-m as a relative frame of reference. In the case of a first responder scenario, reversal of the route 110 waypoint list may provide navigational guidance for a first responder to safely exit a structure, while the merging of multiple waypoint lists into a new route may be used to provide navigational guidance for a first responder to locate and assist another first responder for example.

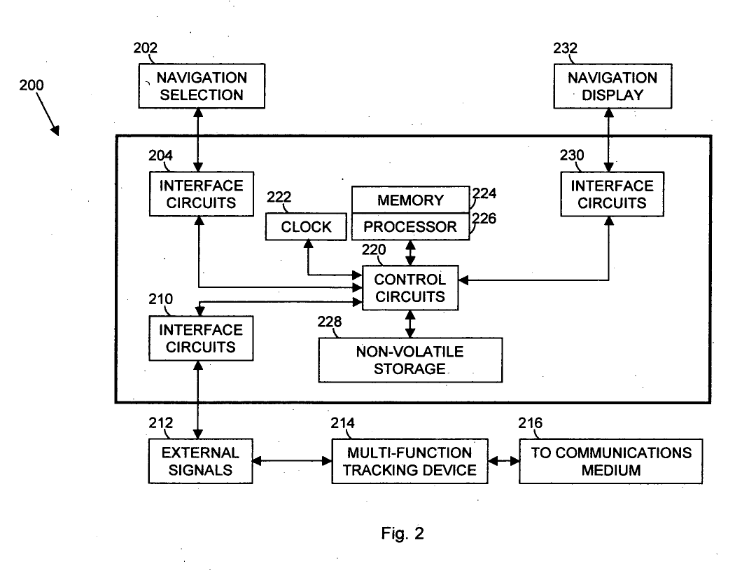

FIG. 2 is a block diagram of a preferred embodiment of multi-function device 200 of the present invention. It will be understood that the device 200 illustrated in FIG. 2 is exemplary only and is not a limitation of the present invention. Those of skill in the art will understand that external signals 212 may include one or more of the following, device position and accuracy information, timestamp for position information, remote selection of navigation guidance to display, commands for managing position and waypoint list information or to manipulate a waypoint list, mesh network communications messages exchanged using the communications medium 216, bearing information related to compass heading and attitude information provided by a multi-function tracking device 214, and other information, all without limitation.

The multi-function device 200 can incorporate control circuits 220 coupled to non-volatile memory 228, interface circuits 204 and 210, clock 222, programmable processor 226 and interface circuits 230. The non-volatile memory or storage unit 228 may be used for purposes of storing control software, navigation selection, configuration information, processed data, waypoint lists, and positions and accuracy information, all without limitation. The device 200 can incorporate additional storage 224 of a type that would be understood by those of skill in the art which could include read/write memory of a volatile or non-volatile form.

Multi-function device 200 can incorporate navigation selection 202 coupled with interface circuits 204, the plurality of which is not a limitation of device 200. In one preferred embodiment, a first responder would be provided a means for selecting a particular type of navigation, including but not limited to, evacuate safely or locate another first responder. Interface circuits 204 can be coupled to control circuits 220, to adapt the signals between navigation selection 202 and control circuits 220. The plurality of navigation selection signals 202 is not a limitation of the present invention.

Interface circuits 210 can be coupled to external signals 212 to adapt the signals between the multi-function tracking device 214 and communications medium 216, and control circuits 220. In one preferred embodiment, the multi-function tracking device 214 and communications medium 216 are as described in the '855 application.

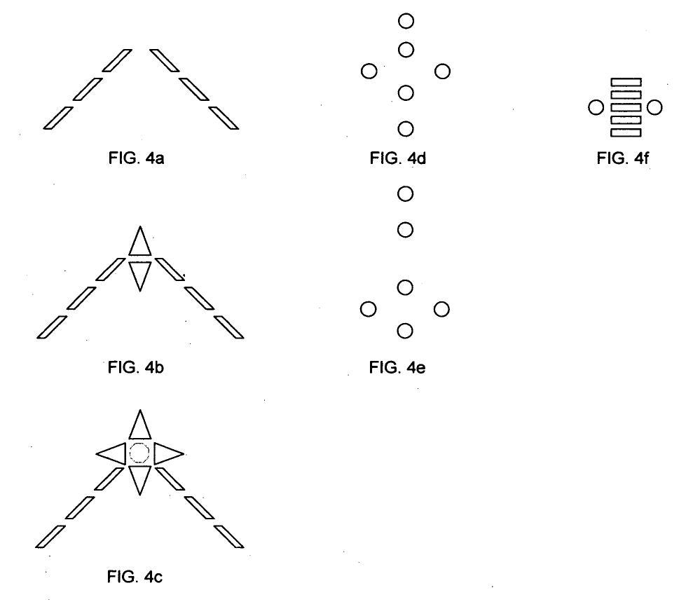

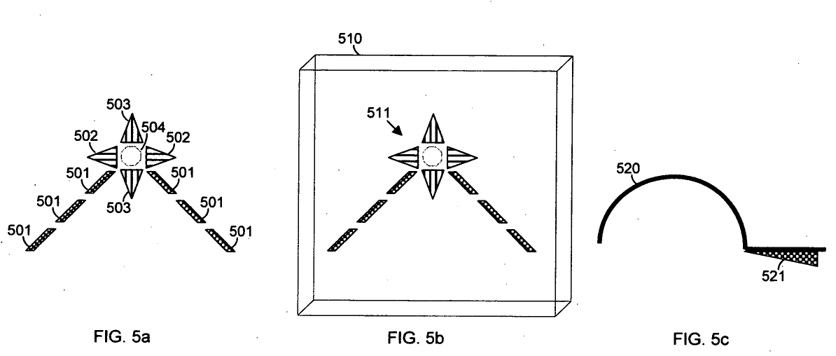

Device 200 can incorporate interface circuits 230 which can be coupled to control circuits 220 to adapt signals between the control circuits 220 and navigation display 232. Those of skill in the art will understand the navigation display embodiment and environment indicates a variety of navigational guidance information, as described in exemplary illustrations FIG. 4a through FIG. 4f, discussed subsequently. Further, the navigational guidance display may preferably be mounted on a first responder helmet brim, FIG. 5c, or a package worn by a user, all without limitation.

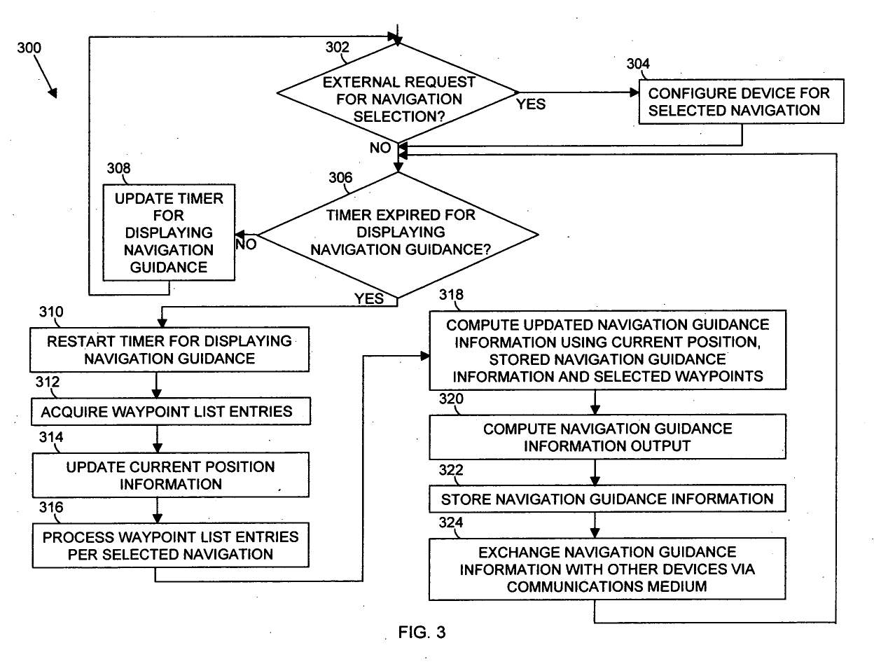

FIG. 3 is a flow diagram of a process 300, executed in whole or in part by each multi-function device 200, see FIG. 2, to acquire position and waypoint information to be processed in a selected manner for navigational guidance display.

In a step 302 a determination is made as to whether a request for selecting the navigational guidance to be displayed requires processing. Such a request may be obtained by the multi-function device from, but not limited to, external signals 212 or via navigation selection 214, as shown in FIG. 2.

In a step 304 a navigational guidance request determined from a step 302 is processed. As would be understood by those of skill in the art, such processing may include, but is not limited to, initialization of selected memory locations, acquisition of current device position and accuracy, exchange of waypoint information, storage of waypoints and position and accuracy information.

In a step 306 a determination is made as to whether the timer providing the periodic indication for updating navigational guidance display information has expired. If the timer has not expired, the timer value is updated in a step 308, and the process 300 returns to determining the presence of a navigation selection request in a step 302.

In a step 310 the expired timer is restarted to provide a periodic interval for updating navigational guidance display information.

In a step 312 the selected waypoint information is acquired from a multi-function device as described in the '855 application and processed in accordance with the selected navigational display configured in a step 304.

In a step 314 the current device position and accuracy information is from a multi-function device as described in the '855 application and processed in accordance with the selected navigational display configured in a step 304.

In a step 316 the acquired waypoint list entries are processed in accordance with the selected navigational display configured in a step 304. As would be understood by those of skill in the art, the waypoint processing 316 by a device may use one or more sets of waypoint data. If a plurality of such waypoints are available, then the processing will take place relative to at least selected waypoints.

In a step 318 the computed new navigation guidance information is computed using data sets including, but not limited to, the current device position and accuracy, stored device position information and selected waypoint information. If a plurality of such data sets are available, then the processing will take place relative to at least selected data sets.

In a step 320 the newly computed navigational guidance information is processed to determine the display output information.

In a step 322 the newly computed display output information is stored in memory locations, such as in non-volatile memory 228, memory 224 and programmed processor 226, see FIG. 2.

In a step 324 information is exchanged with other multi-function devices 200, see FIG. 2, where such information includes, but is not limited to, navigational guidance information for the device, waypoints information, and device position and bearing.

Following step 324 the process 300 returns to a step 302 providing a continuous and timely navigational guidance information and display.

FIG. 4a through FIG. 4f are illustrative navigational guidance displays suitable for use in the present invention. In each of the FIG. 4a through FIG. 4f, the display is composed of elements depicting the current navigational task to be performed by the use, and the anticipated next task. Further, the display may utilize selective illumination levels of individual elements and varying duty cycles for illumination to impart the navigational guidance information. Those of skill in the art will understand numerous other operation modes, in addition to the ones described, are possible and are to be included by this disclosure.

FIG. 5a illustrates one preferred embodiment of the navigational guidance display 232, see FIG. 2, which can include multiple and independently illuminated elements 501 through 504, such as light emitting diodes (LED). Illuminated elements 501 are used to display the current navigational guidance to the user, through various combinations of intensity and duty cycle. In the case of a first responder scenario, elements 501 may be sequentially illuminated to indicate forward progress towards the next selected waypoint, with intensity variations of the left and right side illuminated elements providing lateral navigational guidance. When the first responder is motionless, the elements 501 may be held in a steady-state with variations of intensity on the left and right sides indicating the correct direction to the next selected waypoint.

In FIG. 5a, illuminated elements 502, 503 and 504 are used to impart the next anticipated navigational guidance to the user. Elements 502 are individually illuminated to indicate a left of right turn is anticipated. Combinations of intensity of elements 502 may be used to indicate shallower angles of turn. Illuminated elements 503 behave similarly to elements 502, indicating expected ascent or descent. Illuminated element 504 indicates the user should expect to stop, or slow down.

FIG. 5b depicts one operational environment of a device of the present invention, comprising a package 510 with an externally viewable navigational guidance display 511. The package 510 form and dimensions are not limitations of the present invention. Further, the particular navigational guidance display 511 depicted in FIG. 5b is exemplary only.

FIG. 5c depicts another operational environment 520 of the present invention mounted under the brim of a first responder helmet 521. Such a location places the display out of the user's direct line of sight, but still within the range of vertical peripheral vision.

While particular embodiments of the present invention have been illustrated and described, it is not intended to limit the invention, except as defined by the following claims.

1. A tracking system for acquiring and exchanging 3-D positions to provide navigational guidance to a user, comprising:
a plurality of multi-function devices each defining a frame of reference, at least one of said plurality being adapted to be carried by said user;
a communication link for linking communication between said plurality of multi-function devices to form a mesh network;
said plurality of multi-function devices being adapted to calculate, exchange and process waypoint information indicative of the location of itself, the device carried by said user, and at least one other said device to thereby provide the route taken by said user; and
a display on said multi-function device carried by said user for displaying a 3-D navigation guidance to said user.

2. The system of claim 1, wherein a portion of said plurality of multi-function devices are fixedly located in known positions.

3. The system of claim 2, wherein a different portion of said plurality of multi-function devices are emplaced at relative locations with respect to said known positions.

4. The system of claim 1, wherein each multi-function device periodically updates its calculation exchange and process of waypoint information.

5. The system of claim 1, wherein said display on said multi-function device carried by said user provides hands free 3-D navigation guidance.

6. The system of claim 1, which further includes a plurality of users, each carrying a multi-function device.

7. The system of claim 1, which further includes a switch for permitting the user to determine the form of the navigation signal, said form including at least an evacuation signal for evacuating the area proximate said user, a location signal for locating another multi-function device, and a retreat signal for showing the reverse path taken by said user.

8. The system of claim 7, wherein said switch is activated by said user.

9. The system of claim 7, wherein said switch is activated by an external command.

10. The system of claim 1, wherein said display is adapted to depict a current navigational task and an anticipated next navigational task.

11. A tracking system for acquiring and exchanging 3-D positions to provide navigational guidance to a user, comprising:
a plurality of multi-function device means for defining a frame of reference, at least one of said plurality being adapted to be carried by said user;
communication link means for linking communication between said plurality of multi-function device means to form a mesh network;
said plurality of multi-function device means being adapted to calculate, exchange and process waypoint information indicative of the location of itself, the device means carried by said user, and at least one other said device means to thereby provide the route taken by said user; and
display means on said multi-function device means carried by said user for displaying a 3-D navigation guidance to said user.

12. The system of claim 11, wherein a portion of said plurality of multi-function device means are fixedly located in known positions.

13. The system of claim 12, wherein a different portion of said plurality of multi-function device means are emplaced at relative locations with respect to said known positions.

14. The system of claim 11, wherein each multi-function device means periodically updates its calculation exchange and process of waypoint information.

15. The system of claim 11, wherein said display means on said multi-function device means carried by said user provides hands free 3-D navigation guidance.

16. The system of claim 11, which further includes a plurality of users, each carrying a multi-function device means.

17. The system of claim 11, which further includes switch means for permitting the user to determine the form of the navigation signal, said form including at least an evacuation signal for evacuating the area proximate said user, a location signal for locating another multi-function device means, and a retreat signal for showing the reverse path taken by said user.

18. The system of claim 17, wherein said switch means is activated by said user.

19. The system of claim 17, wherein said switch means is activated by an external command.

20. The system of claim 11, wherein said display means is adapted to depict a current navigational task and an anticipated next navigational task.
